(19) United States
(12) Patent Application Publication
(10) Pub. No.: US 2025/0209263 A1
(43) Pub. Date: Jun. 26, 2025

(54) INTERACTIVE STORY GENERATION METHODS AND SYSTEMS

(71) Applicant: Kazacos AI Pty Ltd, Sydney (AU)

(72) Inventors: Cameron AUME, Sydney (AU); Peter KAZACOS, Sydney (AU)

(21) Appl. No.: 18/990,419

(22) Filed: Dec. 20, 2024

(30) Foreign Application Priority Data
Dec. 20, 2023 (AU) 2023904151

(51) Int. Cl. G06F 40/20; G06K 7/10; G10L 13/08

(52) U.S. Cl. CPC G06F 40/20; G06K 7/10009; G10L 13/08

(57) ABSTRACT

The present disclosure is directed to systems and methods for interactive story generation and presentation. Identification objects, such as cards, may be associated with narrative elements. The system may read the cards using a sensor, such as a card reader, to determine which narrative elements are selected by a user. The narrative elements are then used to generate a story, which is presented to the user, for example using a text to speech converter.

### RELATED APPLICATION

This application claims priority from Australian Provisional Patent Application no. 2023904151 entitled INTERACTIVE STORY GENERATION METHODS AND SYSTEMS. The entire content of this application is incorporated herein by reference.

### TECHNICAL FIELD

The disclosure is broadly directed to methods and systems for generating and presenting stories. Although not so limited, it has particular application as a toy for children, and will be described with reference to that application. However, different embodiments could be used from preschool children up to adults.

### BACKGROUND

Play is an important part of childhood development. Among other things, it promotes the development of cognitive skills, creativity, imagination and psychosocial and emotional development.

Storytelling is also important in childhood development. In addition to the developmental skills mentioned above, storytelling is also associated with language development, increased vocabulary, and the ability to visualise spoken words.

Improving the above developmental skills is also particularly important for children with disabilities, who may struggle with language skills, and fall behind on developmental milestones, at an early age.

Accordingly, the present disclosure is aimed at increasing a child's exposure to storytelling, and doing so in an interactive way. The present disclosure is also conceived with the idea of providing a product that can be used by children with disabilities.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

It is to be understood that, if any prior art publication is referred to herein, such reference does not constitute an admission that the publication forms a part of the common general knowledge in the art, in Australia or any other country.

### SUMMARY

In a first embodiment, there is provided an interactive story generation and presentation system comprising:
a plurality of identification objects, each identifying a narrative element;
at least one sensor to sense and distinguish between the identification objects, to determine selected identification objects by a user;
a story generator to generate a story based on the narrative elements associated with the selected identification objects;
a player to present the story.

The identification objects may be cards encoded with data which the system can use to distinguish between cards. The identifying data encoded on each card can thereby be used to represent particular narrative elements. However, other types of identification objects may be used within the scope of the present invention. For example, in different embodiments, the identification objects could be figurines, or could be shaped as miniature books.

Each identification object may be marked or shaped, with a representation of its associated narrative element. For example, pictures may be printed onto the outside of identification cards, which enables a user to identify the particular narrative element associated with the identification object. Alternatively, figurines may be shaped to represent their associated narrative elements (e.g. a figurine shaped as a dog, to correspond to the narrative element of a “dog”).

In some embodiments, the sensor(s) may comprise near field communication (NFC) or radio frequency identification (RFID) reader(s), to read the encoded data on the identification objects. However, different types of sensors may be used. For example, if the identification objects are shaped as figurines, the sensors may be able to identify the shape or footprint of the figurines, in order to distinguish between different figurines associated with different narrative elements.

The narrative elements may comprise, for example, characters, locations, acts, times (e.g. seasons, times of day, or historical periods), types of story (e.g. funny, adventure, Halloween).

The story generator is preferably a form of generative artificial intelligence (AI), such as a generative adversarial neural network. The generative AI may utilise a large language model. The story generator may be remote from the identification objects and the sensor(s), and accessed via the Internet or other suitable network. Alternatively, the story generator may be locally run on the same device as the sensor and the player. By utilising generative AI to generate stories in this way, each story generated is almost certain to be different, helping to stimulate a child's imagination, creativity, and other cognitive skills.

The player may comprise a speaker to play audio of the story. Accordingly, the system may comprise a text to speech converter, to convert the text of the story into an audio reading to be played by the speaker. In other embodiments, the system may also comprise a display screen to display visual information associated with the story. For example, the screen may display and highlight the text of the story as it is played, or it may display an animation of a particular scene from the story. In some embodiments, the player may comprise audio output through one or more audio sockets, which can connect to interchangeable audio devices (for example, headphones, or dedicated external speakers). If visual information is created for to present the story, a video output may similarly be provided to connect to an external display screen.

In another embodiment, there is provided an interactive story device, comprising:
at least one sensor to sense and distinguish between a plurality of identification objects, to determine selected identification objects by a user, wherein each identification object is associated with a different narrative element;
a story generator to generate a story based on the narrative elements associated with the selected identification objects; and
a player to present the story.

The device may comprise a container, with walls defining a cavity to store the plurality of identification objects. The container may comprise a closure to close the cavity and securely store the identification objects. The device may further comprise a housing to store electronic components of the device, such as the sensor, the player, a memory, and a processor configured to control the sensor, story generator and player.

In another embodiment, there is provided an interactive story generation and presentation method, comprising:
sensing one or more selected identification objects using at least one sensor, the selected identification object(s) having been selected by a user;
determining one or more selected narrative elements associated with the selected identification object(s);
generating a story based on the selected narrative elements; and
presenting the story.

Sensing the one or more selected identification objects may comprise decoding data encoded on the identification objects, for example, if the identification objects are NFC or RFID cards.

Determining the one or more selected narrative elements may comprise reading information (e.g. individual words, or passages of text) encoded directly on the selected identification object(s). The encoded information may be the narrative element(s) themselves (i.e. individual words or text passages that constitute a narrative element, and may be used as a prompt for the story generator). Alternatively, this step may comprise reading an ID for the selected identification object(s), and searching a database (locally or remote) for the narrative element(s) associated with the ID. If a local database is used, it may be updated periodically (for example if new identification objects are created for use with the device), preferably via a network interface.

The story may be generated using a locally-stored story generation program. In this case, the local program may be periodically updated (e.g. via a network interface), and may utilise a large language model (LLM) to create stories. Alternatively, this step may comprise transmitting the narrative elements as prompts to a remote story generator, such as a publicly available generative AI.

In another embodiment, there is provided a computer system comprising:
at least one sensor;
a player;
a processor; and
a memory in communication with the processor, comprising instructions directing the processor to perform any one of the methods described herein.

In another embodiment, there is provided a computer program product comprising computer code embodied in a computer readable medium that, when executed on at least one computing device, performs the method of any one of the methods described herein.

In another embodiment, there is provided a non-transitory computer readable medium comprising instructions that direct at least one computing device to perform any one of the methods described herein.

Different embodiments described above may be combined, and features described in relation to one embodiment may be incorporated with features of other embodiments. Further features, aspects, and advantages will become more apparent from the following description of embodiments, along with the accompanying drawings in which like numerals represent like components.

### BRIEF DESCRIPTION OF THE DRAWINGS

Various embodiments are illustrated by way of example, and not by way of limitation, with reference to the accompanying drawings, which are briefly described below.

FIG. 1 is a schematic view of an interactive story generation and presentation system according to an embodiment.

FIG. 2 is a top perspective view of an interactive story device according to an embodiment, in a closed state.

FIG. 3 is a bottom perspective view of the device of FIG. 2, in an open state.

FIG. 4 is another perspective view of the device of FIG. 2, in an open state, depicting the internal configuration of the device.

FIG. 5 is a flow chart depicting an interactive story generation and presentation method, according to an embodiment.

FIG. 6 is a flow chart depicting an interactive story generation and presentation method, according to an alternative embodiment.

Embodiments will now be described more fully hereinafter with reference to the accompanying drawings, in which various embodiments, although not the only possible embodiments, of the invention are shown. The invention may be embodied in many different forms and should not be construed as being limited to the embodiments described below.

### DETAILED DESCRIPTION

### Apparatus Overview

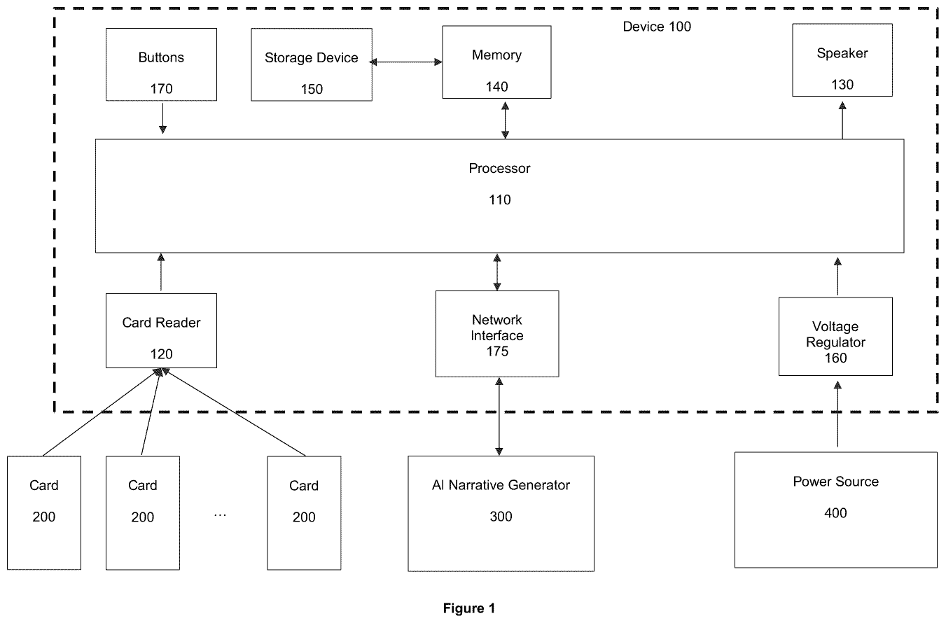

Referring to FIG. 1, an interactive story generation and presentation system is depicted in accordance with an embodiment of this disclosure. The system comprises a device 100, a plurality of identification objects in the form of cards 200, a remote AI narrative generator 300, and a power source 400 to provide power to the device 100. Although the power source 400 is depicted as being external to the device, it will be appreciated that the device 100 could be powered using an internal battery, that could be charged from the power source 400 at a convenient time, enabling the device 100 to be used subsequently when not connected to the power source 400.

The device 100 comprises a processor 110, in communication with a memory 140. The processor is also in communication with card reader 120 to read cards 200, speaker 130 to play the story, and buttons 170 to enable a user to control the device 100. The memory 140 may comprise random access memory (RAM), and can also include a volatile or non-volatile memory device, such as ROM, EEPROM, or any other device capable of storing data. The memory 140 may comprise RAM and may also be in communication with a hard disk drive 150 or other non-volatile memory capable of storing data.

The processor 110 (and/or memory 140) is also in communication with a network/communication interface 175, capable of sending and receiving data. In several embodiments, instructions and/or data for use by the processor 110, in accordance with the present embodiment, may be stored using an external server system and received by the computing device 100 using the communications interface 175.

The processor 110 can include one or more physical processors communicatively coupled to memory devices, input/output devices, and the like. In one illustrative example, a processor may implement a Von Neumann architectural model and may include an arithmetic logic unit (ALU), a control unit, and a plurality of registers. In many embodiments, a processor 110 may be a single core processor that is typically capable of executing one instruction at a time (or process a single pipeline of instructions) and/or a multi-core processor that may simultaneously execute multiple instructions. In a variety of embodiments, processor 110 may be implemented as a single integrated circuit, two or more integrated circuits, and/or may be a component of a multi-chip module in which individual microprocessor dies are included in a single integrated circuit package and hence share a single socket.

Communication devices can include network devices (e.g., a network adapter or any other component that connects a computer to a computer network), a peripheral component interconnect (PCI) device, storage devices, disk drives, printer devices, keyboards, displays, etc.

Although specific architectures for computing devices in accordance with various embodiments are described above, any of a variety of architectures, including those that store data or applications on disk or some other form of storage and are loaded into memory at runtime, can also be utilized. Additionally, any of the data utilized in the system can be cached and transmitted once a network connection (such as a wireless network connection via the communications interface) becomes available. In several embodiments, each computing device provides an interface, such as an API or web service, which provides some or all of the data to other computing devices for further processing. Access to the interface can be open and/or secured using any of a variety of techniques, such as by using client authorization keys, as appropriate to the requirements of specific applications of the disclosure. In a variety of embodiments, a memory includes circuitry such as, but not limited to, memory cells constructed using transistors, that store instructions. Similarly, a processor can include logic gates formed from transistors (or any other device) that dynamically perform actions based on the instructions stored in the memory. In several embodiments, the instructions are embodied in a configuration of logic gates within the processor to implement and/or perform actions described by the instructions.

### Device Construction

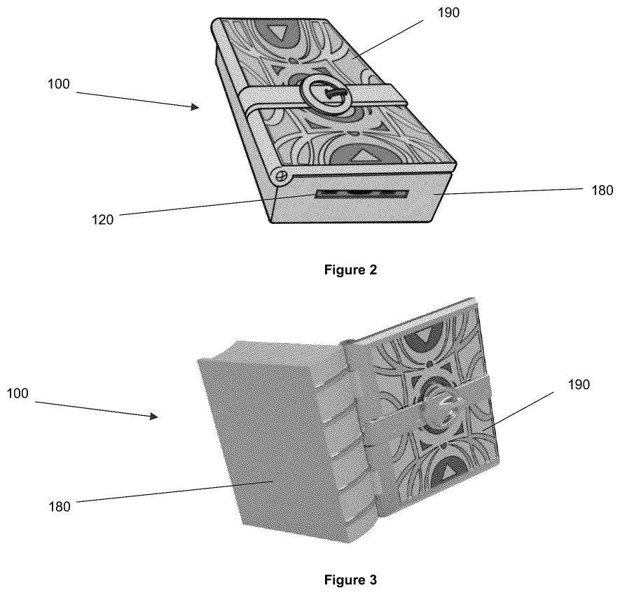

With reference to FIGS. 2 to 4, there is depicted an embodiment of a device 100. The device 100 comprises a box portion 180 and a lid 190 hingedly connected to the box portion 180, to open and close the device 100. The device 100 is envisaged to be of an appropriate size to be held and/or carried by a user, although larger sizes may be provided in different embodiments. Various different device shapes, sizes and configurations are possible.

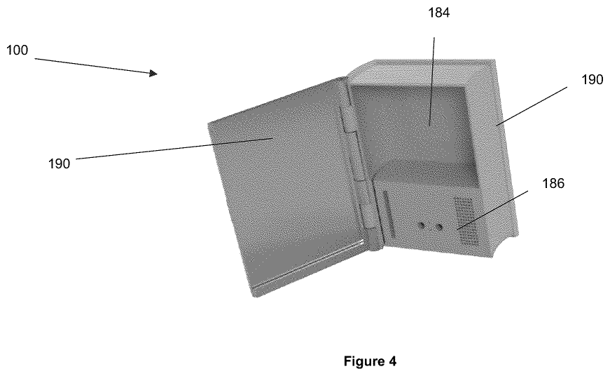

In this embodiment, referring primarily to FIG. 4, a cavity 184 is provided within the device 100, which may be used to store cards 200.

Also shown is a housing 186, which can contain the electronic componentry of the device 100, such as the processor 110, memory 140 and speaker 130.

The device 100 also includes a card reader 120, the slot of which is depicted in FIG. 2, for a user to insert cards 200 into—in this embodiment, cards 200 are inserted one at a time.

A “play” button (not shown) may also be provided, either on the inside or outside of the device 100. Similarly, lights or screens could also be provided on the inside or outside of the device 100. Other buttons or user controls may be included to enable a user to control the functionality of the device. For example, a “replay” button may be provided to allow a user to replay the most recent story.

### Identification Objects and Narrative Elements

In accordance with this embodiment, identification objects 200 are used to allow a user (such as a child) to choose narrative elements for a story. In this embodiment, the identification objects are cards 200, which are encoded with data (e.g. NFC or RFID tags) that can be used to identify them when read using card reader 120. Each card 200 will generally be associated with a different narrative element. By inserting different cards into the card reader 120, the user can create a story with a different narrative.

The narrative elements may include, for example:
characters to be incorporated into the story, such as dinosaurs, animals (such as dogs or cats. or wild animals), mythical creatures (e.g. unicorns), super heroes, or simply school children, police officers, or other types of people that the children may encounter or generally know of.
locations to be incorporated into the story, such as a magical forest, a zoo, a school, a mountain, a castle, a river, or specific famous places or countries in the world.
acts to be incorporated into the story, such as gift giving, playing a sport, flying, hiding, etc.
times to be incorporated into the story, such as summer or other seasons, morning or evening, sunset or sunrise, six o'clock, or historical periods etc.
types of story, such as funny stories, adventure stories, Halloween stories, or stories on educational topics such as recycling and healthy eating.

In some embodiments, narrative styles may also be specified using cards (e.g. a particular voice or style of reading the story), although these may not be provided to the story generator, and may instead be used by a text-to-speech converter when preparing the story audio to be played.

The cards 200 may have markings on them, allowing the user to recognise and select the associated narrative elements. Because the primary users of the system are envisaged to be children (or their parents), the markings are preferably simplified depictions of the associated narrative elements—i.e. pictures printed on the cards. Photographs may also be used.

However, different types of markings may be used. For example, words or text describing the narrative element may be used instead of or in addition to the picture—e.g. a picture of a dog may be printed on a card 200, along with the word “dog”. This can help a child to select a dog as a narrative element for their story, while also providing an opportunity for the child to learn or practice reading the word “dog”. This allows the device 100 to provide additional learning opportunities, as well as allowing a child to explore and develop their imagination and creative abilities.

In another embodiment, the cards 200 may have Braille cells formed on their surface, to assist vision-impaired users to distinguish between cards 200 associated with different narrative elements.

Although many embodiments of the system will use preprogramed cards 200, other embodiments may include customisable/programmable cards, to allow a user to define their own narrative elements. For example, a user may wish to insert themselves and/or their siblings into a story. Alternatively, the user may watch a video on the Internet, and be prompted to program a card for a narrative element associated with the video (for example, a particular animal or person featured in the video, who could be incorporated into future stories).

The custom narrative element may by encoded onto a card 200 using text or voice input from a user. The card 200 may be custom programmed using the device 100, or the custom programming may performed using a separate computer with dedicated software and/or hardware, enabling this function. The custom programming may be achieved using a web or phone app associated with the device 100.

Although embodiments are herein described primarily with reference to cards 200 to be read by an NFC or RFID card reader 120, different types of identification objects 200 may be used in other embodiments. For example, figurines representing the narrative element may be used in some embodiments, which (depending on the type of sensor used) may be encoded with unique identifying data (again, such as NFC data or RFID tags), or may be formed in a distinguishable shape to allow the selected narrative element(s) to be determined when the figurine is presented to the sensor.

### Sensor Operation

In embodiments of the present disclosure, the sensor(s) are card readers 120 configured to read Or scan NFC data or RFID tags from cards 200 of the present embodiment. Such card readers 120 may include a slot to allow a user to insert a selected card 200, as shown most clearly in FIG. 2. However, in other embodiments, the card reader 120 may not include a slot, and could simply detect when the card 200 is placed near the reader 120.

Although an NFC card reader may utilised as the sensor 120 of the present embodiment, other configurations may be utilised. For example, in a simple variation involving a mechanical sensor, each identification object could have a physical profile (e.g. a key profile with ridges and recesses) that can be detected by the sensor 120 to distinguish between different identification objects. The identification object 200 could be pushed into the sensor 120, such that its key profile displaces a combination of moveable parts of the sensor. The sensor 120 may accordingly be configured to distinguish a particular key profile by the combination of the displaced parts. Similarly, a particular footprint of a figurine may be detected using a similar manner, when the figurine is placed on, or pushed onto, a sensor.

Multiple sensors 120, or combinations of sensors may be used in accordance with different embodiments of this disclosure. For example, different card readers 120, each with their own slot, could be provided for different types of narrative element—e.g. there could be a main character slot to receive a character card 200, a location slot to receive a location card 200, a time slot to receive a time card 200, etc.

Regardless of the particular type of sensor(s) 120, they may be configured to provide a confirmation tone or light, to confirm when a particular identification object 200 has been successfully read. A sound associated with the narrative element may be played, at that time (e.g. the name of the narrative element, or an associated sound such as a theme song of a super hero, or a revving engine for a car). The sensor(s) 120 may also be configured to provide a negative tone or light, if they detect that an identification object 200 was presented, but the identification object was not successfully read (e.g. the identification tag was not fully obtained, or does not relate to a narrative element recognised in a database accessed by the device 100).

When the sensor(s) 120 identify a particular identification object 200 (e.g. a tag for a particular card), the information may be passed to the processor 110, to determine and process the associated narrative element. The processor 110 may search a local database, or a remote database for the tag identified by the sensor 120, to determine the narrative element(s) associated with the selected identification object 200.

The sensor(s) 120 may detect identification objects, sequentially (one after another), for use in a single story. The start of a sequence may be initiated by pressing of a “play” button on the device 100, and ended by pressing of the “play” button again. Other operational steps are possible, depending on the number and type of buttons configured on the device 100.

There may be a limit on the number of identification objects 200 that can be read for a particular story.

### Narrative Generator

Once the desired number of identification objects 200 have been read, and the processor 110 has identified the associated narrative elements, this information can be used to generate a story. The selected narrative elements may be combined into a prompt for a generative AI system 300.

Embodiments may add additional content into the story prompts. For example, the additional information may include educational lessons, dilemmas, or more personalisation to the stories, based on information that may have been provided during set-up and configuration of the device 100. For example, this may include the name, age, sex, location, family composition or year level of the user(s), or any medical challenges that the user may face (e.g. a child with a disability). Parents may be able to control attributes of the story, either by providing input when first setting up the device 100, or dynamically using a separate control program (e.g. a web or phone app, which can control or configure the device via network interface 175).

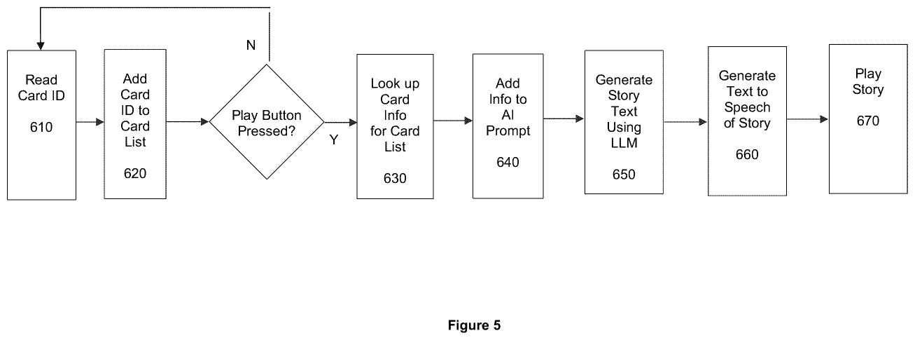

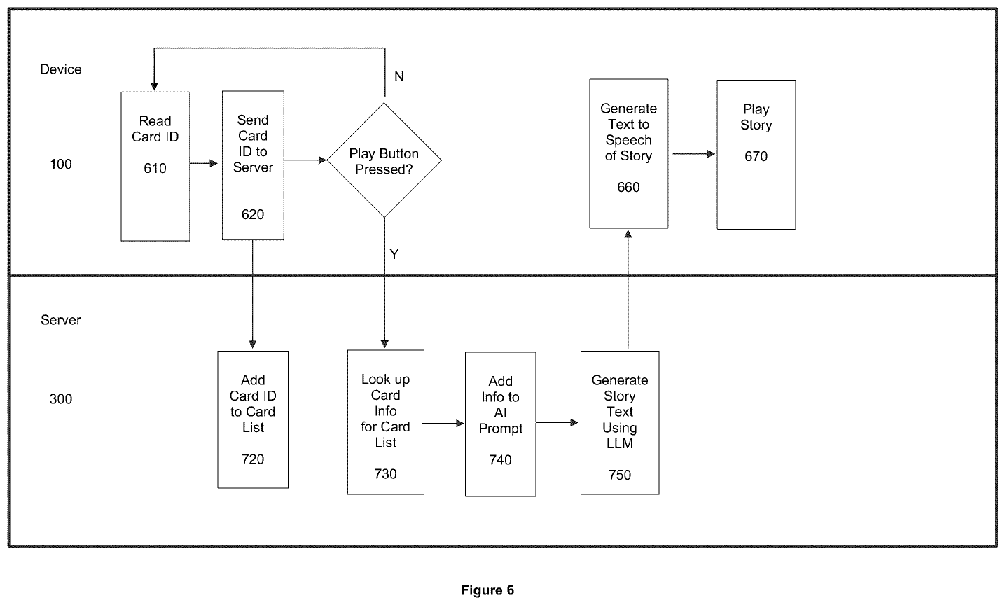

This generative AI system 300 comprises an LLM, which can take the prompts and create a story based on those prompts. The LLM may be run locally on the processor 110, or it may be run on a remote server. FIG. 5 depicts the operation of the embodiments of this disclosure, when using a remote LLM engine 300, while FIG. 6 depicts the operation of a local LLM engine.

Embodiments of the disclosure may use an external, commercially-available LLM engine, or may use a bespoke LLM engine.

In either case, the processor 110 formats the prompt to the LLM 300, based on the selected narrative elements, and based on other information that may be, for example:
configured within the basic control program of the device 100,
configured when first setting up the device 100, or
configured by a parent of a child using the device 100, via a separate control program accessible via their phone or via the web.

The AI prompt may also be formatted to prioritise/emphasise particular narrative elements, for example based on the order in which the associated identification objects 200 were detected by the sensor. For instance, narrative elements associated with earlier-detected identification objects 200 may be provided a higher weight in the prompt.

The formatted prompt is provided to the LLM 300—either via network interface 175, or internally on the processor 110. The LLM 300 then returns the text of a story based on the prompt.

### Text-to-Speech Engine

Once the text of the story has been received from the LLM 300, a text-to-speech (TTS) engine may be used to produce an audio version of the story.

The TTS engine may be configurable to use different voices or narrative styles. For example, a child may be able to a narrative style card in that identifies a particular narrator (e.g. a male or female narrator), causing the TTS engine to produce an audio version of the story, in the selected style (e.g. with a male or female narrator). Alternatively, a default narrator may be specified upon a device's initial configuration, or using a web or phone app to configure the device 100 dynamically.

The TTS engine may run on either the processor 110 of the device 100 itself. Alternatively, in other embodiments, the TTS engine may be run on a remote server, and the device 100 may receive a spoken audio file from the remote server via network interface 175.

### Presentation of the Story

In this embodiment, the player 130 used to present the story is simply an audio speaker, which plays the audio output of the TTS engine. In some embodiments, the player may comprise audio output through one or more audio sockets, which can connect to interchangeable audio devices (for example, headphones). If more than one audio output is provided, multiple people could listen to the story at the same time, while each wearing headphones—for example, a child and their parent(s), or a child and their friend(s).

In some versions, sound effects may be added, associated with particular narrative elements. Specific sound effects may be associated with particular narrative elements—for example, a super-hero's signature sound may be played whenever the super-hero is mentioned in the story. Particular sound effects may be associated with a narrative element, in the narrative element database described previously, and looked up by the processor 110 for playback when playing the story.

In some embodiments, the player 130 may include mechanical outputs, which can cause motion of the device 100 at appropriate times in the story. Again, particular types of motion may be associated with different narrative elements. For example, the device 100 may be caused to undergo a rolling motion while the player 130 is playing a story about the sea (as a narrative element), whenever the sea is mentioned in the story.

In other embodiments, the player 130 may comprise a display screen, to display visual images associated with the story. For example, it may display pictures associated with the associated narrative elements. These may be the same as or similar to markings on the identification objects. Alternatively, a variety of visual depictions of each narrative element may be stored in the narrative element database described previously. The visual depictions may be displayed at appropriate times, for example whenever the story mentions a particular narrative element (e.g. a picture of a character may be displayed, whenever the character is mentioned in the story).

In premium versions of the device 100, the player 130 may be configured to provide an animated version of the story.

The device 100 may also include a printer, or may comprise a printer output to an external printer, which can be used to print the text of the story. Pictures may be added, which are reflective of the narrative elements selected by the user and included in the story. The user can then share their story with others, in a printed form, if they wish.

### Procedural Steps

Referring specifically to FIGS. 5 and 6, flow charts are provided showing two embodiments of methods according to embodiments of the present disclosure.

FIG. 5 depicts an embodiment where the story generation function is run on the processor 110 of the device 100 itself. In this embodiment, when started (e.g. when a “start” button is pressed on the device 100), the device 100 reads 610 a card ID for a card 200 inserted into card reader 120. The card ID is added 620 to the card list for this particular story. More cards 200 can be inserted into the card reader 130, until the user presses the “Play” button on the device 100.

Once the list of card IDs is complete, and the user presses the “Play” button, the processor 110 looks up 630 information relating to the list of card IDs, to identify the associated narrative elements. The narrative elements are then used to create 640 an AI prompt. As previously explained, the AI prompt may also include additional information, on top of the selected narrative elements provided by user via the selected cards 200.

The prompt is then passed to an LLM run on the processor 110, which generates 650 story text based on the AI prompt. The story text is then converted 660 into speech (spoken audio) using a TTS engine. Once the spoken audio has been created 660, the story is played 670 via player 130 (typically an audio speaker 130, as depicted in FIG. 1).

FIG. 6 depicts an embodiment where the story text is created using a cloud-based story generator. In this version, once a card ID has been identified (in the same manner as described above, in relation to FIG. 5), the list of card IDs is created 720 on a remote server. The remote server then looks up 730 the narrative element(s) associated with the card IDs, creates 740 the AI prompt, and provides it to the LLM to generate 750 the story text. The story text is then passed back to the device 100 to be played to the user. The device 100 communicates with the remote server via a network interface 175.

It will be understood that, in different embodiments, different steps may be run on either the device 100 or on a remote server (or combination of remote servers) in accordance with present disclosure, and the invention is not limited to the particular embodiments depicted in FIGS. 5 and 6.

It will be appreciated by persons skilled in the art that numerous variations and modifications may be made to the above-described embodiments, without departing from the scope of the following claims. The present embodiments are, therefore, to be considered in all respects as illustrative of the scope of protection, and not restrictively.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

As used herein and in the appended claims, the singular form of a word includes the plural, unless the context clearly dictates otherwise. Thus, the references “a,” “an” and “the” are generally inclusive of the plurals of the respective terms. For example, reference to “a feature” includes a plurality of such “features.” The term “and/or” used in the context of “X and/or Y” should be interpreted as “X,” or “Y,” or “X and Y”.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An interactive story generation and presentation system comprising:
a plurality of identification objects, each identifying a narrative element;
at least one sensor to sense and distinguish between the identification objects, to determine selected identification objects by a user;
a story generator to generate a story based on the narrative elements associated with the selected identification objects;
a player to present the story.

2. The system of claim 1, wherein the identification objects comprise cards encoded with data which the system can use to distinguish between cards.

3. The system of claim 1, wherein the identification objects comprise figurines.

4. The system of claim 1, wherein each identification object is marked, or shaped, with a representation of its associated narrative element.

5. The system of claim 1, wherein the narrative elements comprise one or more of:
characters,
locations,
acts,
times, or
types of story.

6. The system of claim 1, wherein the story generator comprises a large language model.

7. The system of claim 1, further comprising a text-to-speech engine, wherein the player comprises an audio speaker, and wherein the text-to-speech engine converts a text of the story generated by the story generator into audio to be played by the audio speaker.

8. An interactive story device, comprising:
at least one sensor to sense and distinguish between a plurality of identification objects, to determine selected identification objects by a user, wherein each identification object is associated with a different narrative element;
a story generator to generate a story based on the narrative elements associated with the selected identification objects; and
a player to present the story.

9. The device of claim 8, wherein the device comprises a container with walls defining a cavity to store the plurality of identification objects.

10. The device of claim 9, wherein the container comprises a closure to close the cavity.

11. The device of claim 8, further comprising a housing to store electronic components of the device.

12. An interactive story generation and presentation method, comprising:
sensing one or more selected identification objects using at least one sensor, the selected identification object(s) having been selected by a user;
determining one or more selected narrative elements associated with the selected identification object(s);
generating a story based on the selected narrative elements; and
presenting the story.

13. The method of claim 12, wherein sensing the one or more selected identification objects comprises decoding data encoded on the identification objects.

14. The method of claim 13, wherein the identification objects are NFC or RFID cards.

15. The method of claim 12, further comprising converting a text of the story into spoken audio using a text-to-speech engine, and wherein presenting the story comprises playing the spoken audio.

16. The method of claim 12, wherein generating the story comprises preparing a prompt based on the one or more selected narrative elements, and providing the prompt to a large language model.

17. The method of claim 16, wherein preparing the prompt comprises adding additional information based on a configuration for the story.

18. A computer system comprising:
at least one sensor;
a player;
a processor; and
a memory in communication with the processor, comprising instructions directing the processor to perform any one of the methods of claims 12 to 17.

19. A computer program product comprising computer code embodied in a computer readable medium that, when executed on at least one computing device, performs the method of claim 12.

20. A non-transitory computer readable medium comprising instructions that direct at least one computing device to perform the method of claim 12.
